(19) United States
(12) Patent Application Publication
(10) Pub. No.: US 2009/0299777 A1
(43) Pub. Date: Dec. 3, 2009

(54) Hotel reservation system without check-in

(76) Inventor: Hersh Silberman, Brooklyn, NY (US)

Correspondence Address: STEVEN HOROWITZ, ESQ., 295 MADISON AVE, SUITE 700, NEW YORK, NY, 10017, US

(21) Appl. No.: 12/156,334

(22) Filed: May 30, 2008

(51) Int. Cl. G06Q 10/00

(52) U.S. Cl. 705/5

(57) ABSTRACT

A hotel reservation system comprises hotel rooms having combination locks electronically set so as to be openable by any one of a plurality of combination codes whenever the combination code is inputted. A computer system accessible through a telecommunications network allows remote sign-in and reservation of a hotel room for a check-in date under a guest identity by payment and selection of a combination code specific to the hotel room. The computer system, upon electronic notification of a selection of a combination code, automatically electronically may set or schedule the setting of the combination lock controlling entry to the reserved hotel room. The computer system may be programmed to automatically electronically set the combination lock at a set time on the check-in date. The hotel may maintain digital records of the codes for each room and of instances of entry into the room using the code.

### BACKGROUND OF THE INVENTION

The present invention generally relates to apparatus and methods for hotel reservation and related systems and, more particularly, to apparatus and methods of improving hotel reservation, check-in and security.

Check-in at hotels is time consuming. Checking in and obtaining a room also involves obtaining a key to the room. For the hotel guest, carrying around a key is a burden and furthermore the key can be lost. Women's elegant clothing often does not have pockets for carrying around things. Even magnetic cards are a burden to carry around and they too can be lost. Also magnetic cards can lose their data when placed near a cell phone. Regular combination locks on the hotel door would require for security reasons changing the combination all the time for each new occupant.

As can be seen, there is a need to find new ways to make hotel reservation and check-in more convenient.

### SUMMARY OF THE PRESENT INVENTION

In one aspect of the present invention, there is presented a method of hotel reservation without check-in, comprising remotely signing in to a hotel computer system under a guest identity; reserving a room of the hotel by computer under the guest identity for a set date, the computer in communication with the hotel computer system; selecting a code by computer and electronically transmitting the code to the hotel computer system; the hotel computer system electronically setting the code as a combination code on a lock of the room at a set time calculated in relation to a check-in time on the set date.

In a further aspect of the invention, there is presented a hotel reservation system, comprising a plurality of hotel rooms, each hotel room having a combination lock that controls entry into that hotel room, the combination lock capable of being electronically set so as to be openable upon input of any one of a plurality of combination codes at the combination lock; a computer system accessible through a telecommunications network and allowing remote sign-in and reservation of a hotel room for a check-in date from among the plurality of hotel rooms under an identity by payment and selection of a combination code specific to the hotel room, the computer system, upon electronic notification of a selection of a combination code, automatically electronically setting the combination lock controlling entry to the reserved hotel room so that the combination lock is openable by entering that combination code.

In another aspect of the invention, there is presented a reservation system, comprising a plurality of rooms, each room having a combination lock that controls entry into that room, the combination lock capable of being electronically set so as to be openable by any one of a plurality of combination codes whenever the one of the plurality of combination codes is inputted at the combination lock; computer hardware and software, the hardware linked to a computer system website, the software allowing at the web site a guest to sign in, reserve and pay for a room for a check-in date from among the plurality of rooms, the software prompting and accepting selection of a combination code specific to the room, the computer hardware and software, upon electronic notification of a selection of a combination code, automatically electronically setting the combination lock controlling entry to the reserved room so that the combination lock becomes openable merely by entering that combination code.

These and other features, aspects and advantages of the present invention will become better understood with reference to the following drawings, descriptions and claims.

### BRIEF DESCRIPTION OF THE DRAWINGS

FIG. 1 is a schematic drawing of a system in accordance with the present invention; and

FIG. 2 is a flow chart showing a method of the present invention;

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a system and method whereby someone may reserve a room in a hotel, through a telecommunications network, for example online, identify themselves on the hotel computer system linked to a hotel web site and then may schedule the setting et the combination on the lock of the door of that room by selecting a code online and transmitting it to the hotel. At some point prior to a check-in time on the day selected as the first day of the reserved hotel stay, at the scheduled time, which time may be fixed by the hotel in relation to check-in time (for example noon), the setting of the combination code on the combination lock may be automatically and electronically effectuated in accordance with the combination code selected by the guest online. After entering the room, the guest and/or the guest's family staying with the guest, during the guest's stay in the hotel, could once again access the hotel computer system by computer through a telecommunications network that is global (i.e. the internet) or local, sign in under the guest's identity and alter the combination code and/or add additional combination codes for the combination lock for the hotel room of the guest.

In contrast to the prior art, in which a combination code for the hotel room may be selected by the hotel, the present invention may utilize a combination code or codes that may be selected by the guest, which may make it easier for the guest to remember. In further contrast to the prior art, in which access to a hotel room may require carrying around a key, a magnetic card, a device to communicate with a lock or another object, the present invention may avoid the necessity of having to carry anything around when accessing hotel rooms in a secure manner and may avoid the cost of generating these carry-on objects. In contrast to the prior art, in which hotel reservations are often accompanied by lengthy waits during check-in, the hotel reservation of the present invention may not require any check-in at the hotel, or may require a nominal verification of identity. In contrast to the prior art, wherein a room has a single combination code, the present invention may allow various individuals within a family to have their own password or combination code to be used to get into the hotel room, since the system accommodate multiple codes. In contrast to the prior art, in which the hotel management would not know if someone checked into the room that has been reserved without meeting the person, the present invention may allow electronic transmission of the fact that the combination lock was opened to be recorded in the hotel computer system. In further contrast to the prior art, in which the identity of the person who entered a room is not immediately discernable by the hotel, the present invention may allow the hotel computer system to maintain a record sufficient to identify who must have been present when the hotel room was opened at a particular time, which may be useful for security reasons. In contrast to the prior art, in which the means of entering the hotel room (i.e. key, magnetic card, combination) may be set once and may be effectuated when it is set, the present invention allows a guest to schedule in advance the setting of a combination code for an electronic combination lock on the door of the guest's hotel room.

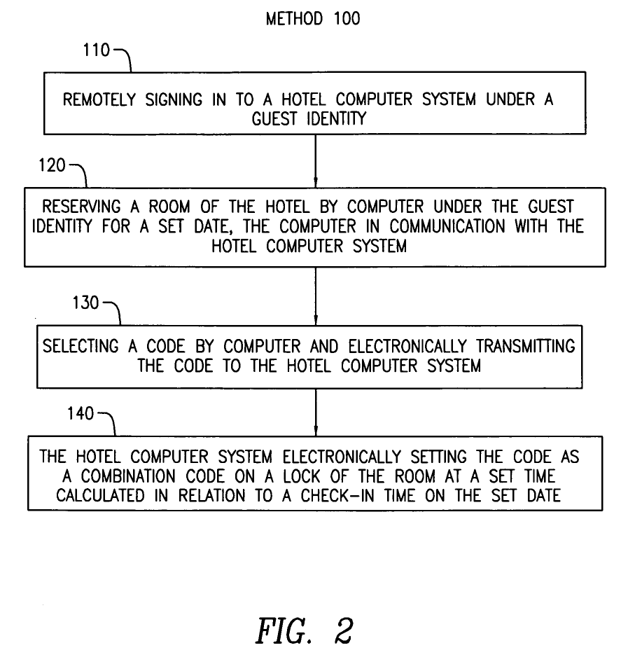

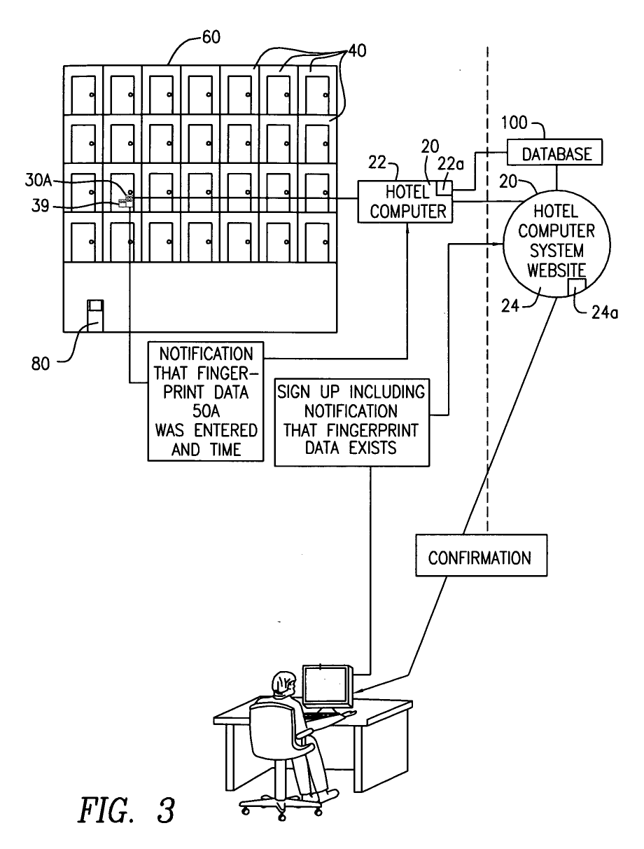

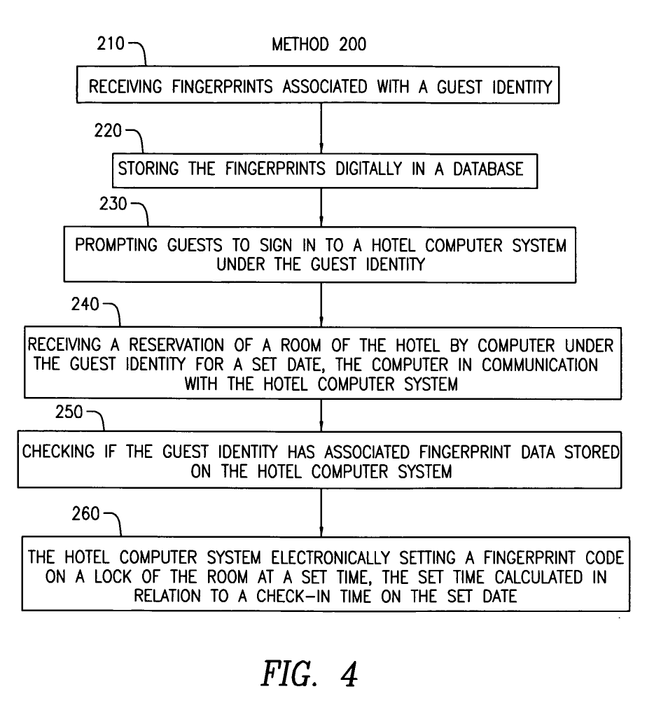

As seen from FIG. 2, the present invention may be viewed as a hotel reservation system 10. Hotel reservation system 10 includes a plurality of hotel rooms 40 of a hotel 60. The system 10 may also be applicable to other places (real or virtual) having a plurality of rooms whose occupants change over time. Each hotel room 40 may have a combination lock 30 that may control entry into that hotel room, for example by being positioned on a door, as is common. Combination lock 30 may be capable of having its combination set electronically so as to be openable upon input of any one of a plurality of combination codes at the combination lock 30. To accomplish this, combination lock 30 may be connected with electric wires or wirelessly to an electronic network that is connected to a computer, for example a hotel computer 22.

System 10 may also include a computer system 20 accessible through a telecommunications network, for example a global or local telecommunications network. Computer system 20 may include hotel computer 22 and hotel web site 24 and thereby may allow guests to remotely sign-in and reserve a hotel room 40 beginning on a check-in date from among the plurality of hotel rooms 40. A guest accessing the hotel web site or another web site linked to hotel computer 22 may have to sign in or otherwise establish or verify a previously establish identity. This may be done through various methods well known to those skilled in the art. For example, identity may be established by providing a piece of data uniquely associated with the guest, for example a social security number, a credit card number, or any other data. Identity may also be established in less traditional ways. For example, a fingerprint database may be maintained by the hotel. The guest may provide the fingerprint data in person on one occasion or else the fingerprint data may be converted to digital form and provided electronically, for example by computer.

After establishing identity the guest or prospective guest may then, under his or her identity, pay for the room. The hotel computer system 20, for example software 24a at hotel web site 24, may prompt the guest to select a combination code specific to the hotel room reserved.

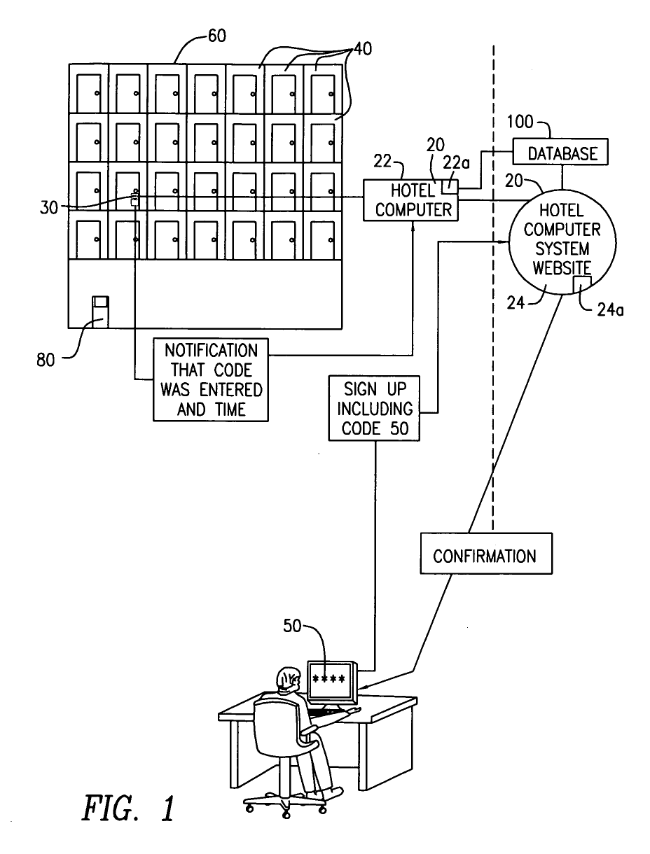

Software 24a of computer system 20 may send an automatic notification to hotel computer 22 electronically that the guest has selected a particular combination code 50. Software 22a associated with hotel computer 22 may then, automatically electronically send an instruction to a combination lock 30 associated with room 40 that electronically sets the combination code 50 as the code for that combination lock for that room. In accordance with computer systems, this instruction may occur at the scheduled time, or may occur immediately to be effectuated at the scheduled time. As seen from FIG. 1, computer system 20, and in particular software 24A, may also send a confirmation notification to the guest's computer that a particular combination code has been selected and/or as to the particulars of the reservation.

Combination lock 30 may control entry into the reserved hotel room. Once the combination code 50 is set on combination lock 30, combination lock 30 may be openable by entering that combination code 50, for example by inputting a keypad adjacent, or as part of, combination lock 30 for that room 40.

The present invention further contemplates that computer system 20 may be programmed to automatically electronically set the combination lock on the check-in date. Computer system 20 may be further programmed to automatically electronically set the combination lock at a set time on the check-in date, the set time calculated in relation to a check-in time. For example, whenever a guest responds to the prompt and selects a combination code 50 for a reserved room 40 at a web site or other location, the computer system 20 may automatically schedule combination lock 30 to be programmed with the selected combination code 50 fifteen minutes before the check-in time on the first date of the reserved dates in the hotel reservation. The set time may be calculated so that the lock 30 is ready for the guest prior to the earliest possible time of the guest's arrival to the room.

If for whatever reason the hotel does not wish the guests to set the combination code on the combination lock of a room automatically without input from hotel management, the computer system 20 offers the option for hotel management to select “storage mode”. By selecting storage mode on the hotel computer 22 or other portion of the hotel computer system 20, when the hotel computer 22 receives electronic transmission of a combination code 50 from a guest for a room in the hotel, the hotel computer 22 may first store the combination code 50 in its database 100 and not immediately automatically transmit instructions to the electronic combination lock 30 to be set with the combination code 50 selected. Hotel management may later send the combination code 50 to the combination lock for the reserved room when it chooses to do so. Accordingly, the electronic transmitting of the code to the hotel computer system and the electronic setting of the code as a combination code on the lock of the room at the set time occur automatically separated by an intervening act of a hotel personnel if storage mode has been selected. It is noted that database 100 may be in cyberspace or may be electronically linked to hotel computer 22 without being in cyberspace.

If storage mode has not been selected, the electronic transmitting of the code to the hotel computer system and the electronic setting of the code as a combination code on the lock of the room at the set time may occur automatically at the same time if the guest has already arrived and is merely re-setting or adding combination codes. If the guest is making a new reservation, the effectuating of the setting of the combination code on the combination lock at the set date may in any event not occur simultaneous with the transmission of the code 50 by the guest since the guest may be selecting the code and reserving the room well in advance of the set date. In this case, there may be an intervening time between the time of electronic transmission of the code 50 to the computer system 20 during reservation and the set time. On the other hand, in certain embodiments, it is contemplated that hotel management pay prefer that once the guest has reserved and paid for the room, and selected and transmitted the combination code 50 to the hotel computer system 20, the hotel computer system 20 may immediately and automatically transmit the selected combination code 50 to the combination lock 30 for the reserved room with instructions to immediately implement and then actually immediately effectuate the setting of the code on the lock of the room.

The system 10 may also allow the hotel management to select “storage mode” for only specific rooms/guests. For example, if the hotel feels that a particular guest or group of guest, due to the age may select new combination codes too frequently, it can select storage mode for the rooms occupied by those guests only while allowing the remainder of the hotel to operate more automatically on the regular mode.

If the guest selects an arrival time later than the check-in time, the arrival time may substitute for the check-in time so that the set time that the combination lock is set with the combination code may be calculated in relation to the arrival time.

Once the guest has arrived and has inputted the combination code at the combination lock, i.e. has entered the room, if the guest or other members of the guest family thereafter, during the date period of the reservation stay in the hotel, selects a new combination code by accessing the hotel computer system under the guest identity either online or at a special kiosk set up on-site, i.e. in the hotel lobby, then the new combination code may be electronically transmitted to the hotel computer and from the hotel computer to the combination lock. In this case, the computer system may thereby immediately electronically set the new code as the combination code on the lock of the room, rather than scheduling the setting of the code on the lock for a future time.

In an alternative embodiment, even after entry of the guest into the room, a new selection of a new code under the guest identity may still allow the guest to schedule the setting of the code on the lock for a future time, provided the future time is within the stay of the guest in the hotel.

The on-site check-in kiosk 80 may have telecommunications access to the computer system 20.

In an alternative embodiment, the present invention also contemplates that instead of accessing the hotel computer system 20 by accessing the hotel web site or by accessing another web site linked to hotel computer 22, a guest may also call on a telephone to establish an identity. The guest may also pay and reserve the room over the telephone and provide a combination code 50 over the telephone. The guest using the telephone to establish an identity, pay and reserve a room may interact with hotel computer 22 using the telephone keypad. In this scenario the computer 22 may answer the guest's telephone call and prompt selection of a code 50, prompt the guest to provide payment information such as credit card details, and prompt the guest to provide room reservation data such as dates of staying in the hotel, number of persons, type of room, etc. In other variations, the clerk of the hotel may answer the telephone call from the guest, take credit card information and optionally certain other aspects of the reservation and then connect the guest to the computer 22 to continue with providing the code 50

In either case, once the guest has inputted the code 50 to the hotel computer 22 via the telephone keypad of the guest, the hotel computer system 20 may automatically transmit code 50 to the reserved room to set the lock or schedule its being sent to the room to set the combination lock of the room at a later time, in accordance with the present invention. The guest, after arrival, may also re-set the combination code or add combination codes automatically by computer as before.

In accordance with the present invention, the hotel computer system 20 may maintain and may update in a timely fashion, digital records, the digital records cross-referencing combination codes 50 selected by guests during reservation sessions through the hotel computer system with hotel rooms 40. These and the below referenced records may be electronically accessible conveniently by hotel management and may be stored in a database 100, which may be linked to hotel computer 22 and/or hotel computer system web site 24. Furthermore, the hotel computer system may maintain, and may update in a timely fashion, records of each instance and the time when a particular hotel room 40 has been entered by means of an input of the combination code 50 for that room. In this way, hotel management may know when a guest has arrived since the combination code selected by the guest may be recorded as having been used to enter that particular room. In this way, the hotel may be able to distinguish between which guest had to be present adjacent the lock 30 when the room was opened at a certain time. This may be useful for security purposes. This may further allow the hotel to distinguish entrances by guests from entrances into the room by hotel service, a maid or other personnel or a thief entering the room. In the case of a guest, for example, the combination code selected by the guest was used on lock 30. In contrast, the maid may have a default combination code provided y the hotel, which may differ from the combination code provided by the hotel to room service for example.

These records of who entered the room and at what time may be ascertainable by virtue of the fact that when someone inputs the combination code 50 at the combination lock 30 when standing next to the room 40, this act may trigger an electronic message from the combination lock 30 to the hotel computer 22, as seen from FIG. 2.

The present invention contemplates that there could be instances when hotel management may wish to verify the identity of a guest in person at the hotel. For example, this could alleviate the risk of someone stealing the identity of a person and then reserving the room under their name.

The computer system 20 may include everything necessary for such system 20 to effectively perform the steps described in accordance with the method and system of the present invention. The computer system 20 may include a hotel web site 24, a hotel computer 22 and software 22A associated with the hotel computer. Accordingly, it should be appreciated that computer system 20 as described herein is not limited to the exact structure and composition described but may be any suitable computer system that can carry out the purposes of the present invention.

As seen from FIG. 1, the present invention may also be viewed as a method 100 of hotel reservation without check-in, comprising several steps. Method 100 may include a step 110 of remotely signing in to a hotel computer system under a guest identity. Alternatively, the guest may establish the guest identity by calling the hotel and interacting with the hotel computer using the telephone keypad. Method 100 may also include step 120 of reserving a room of the hotel by computer under the guest identity for a set date. Reserving the room may include stating an intention to use such a room, paying for the room and/or selecting the type and size of room as well as any other pertinent information. The set date may refer to information identifying the first date of the reserved period. The computer referred to in step 120 may be a computer that accesses a hotel web site, the hotel web site being in communication with the hotel computer forming part of the hotel computer system. Alternatively, the room may be reserved by calling on the telephone and using the telephone keypad when the hotel computer answers the call and prompts interaction with the guest. Method 100 may also include a step 130 of selecting a code and electronically transmitting the code to the hotel computer system. The code may be selected by using a computer to connect and transmit to the hotel computer or in some cases by using a telephone and its keypad to call and transmit to the hotel computer. Accordingly, when the guest selects and transmits the code in step 130 the code is automatically scheduled to be effectuated on the set date, which may be the date of first arrival in the hotel based on the reservation.

Step 140 may involve the hotel computer system electronically setting the code as a combination code on a lock of the room at a set time calculated in relation to a check-in time on the set date. Step 140 then in effect effectuates the request to have the lock have that selected combination code. Method 100 may further comprise a guest opening the lock of the room by manually inputting the code at the lock of the room.

Method 100 may also involve allowing the guest to schedule a time of arrival on the set date. For example, the guest may schedule an arrival for 3 p.m. on the set date. In this scenario, the effectuating of the setting of the combination code on the combination lock in the room may need to match the time of arrival. Accordingly, while step 130 may normally schedule the effectuating of the setting of the combination code on the lock for a time on the set date that is calculated with respect to a check-in time, for example 15 minutes before hotel check-in time, in this case, since the guest has selected a particular arrival time, which may be later than check-in time, step 130 may schedule the effectuating of the setting of the combination code on the lock for a time on the set date that is calculated with respect to the arrival time. If arrival time is 3 p.m., for example, the combination lock may be scheduled to have the combination code selected by the guest at 2:45 pm on the set date of arrival.

Method 100 may also include maintaining and updating timely digital records, the digital records cross-referencing combination codes with hotel rooms, the records electronically accessible to a hotel management. Method 100 may also include recording in the hotel computer system a time of opening of rooms of the hotel by an entering of the combination code associated with the rooms. Method 100 may further include having the records of instances of opening of rooms accessible to a hotel management. This may also include verifying the identity of a guest in person at the hotel.

Method 100 may also involve checking out of the hotel by re-setting by computer the combination code of the room.

In accordance with the present invention, when the hotel check-out time on the date of the last day of the guest's hotel stay passes, the combination code may be automatically re-set to a default code chosen by the hotel.

In a fingerprint version of the present invention, fingerprints 55 may be used instead of a combination code 50. In accordance with this embodiment, a guest, during an initial stay at a hotel, may provide fingerprints 55 to the hotel, for example in person, in connection with a chosen identifier such as a password. The hotel may convert the fingerprints 55 into digital form and store the fingerprints on the hotel computer 22 in connection with the guest identity or identifier. Then when the guest may wish to reserve a room in the same hotel, the guest may follow the same procedures outlined above for a combination code. That is, the guest may log in to the hotel web site 24 (or kiosk 80) by computer under a guest identity and reserve and pay for a room. System 10 employing software 22A or other software may recognize that the guest has fingerprint data associated with his password/guest identity. Accordingly, instead of prompting the guest to select a combination code to be applied to a lock 30 of the reserved room, the guest may be prompted to request that or be notified that the room may be one that has a fingerprint identity input device associated with the lock 30A on the room 40. Alternatively, the guest may be asked whether a fingerprint or fingerprint data has previously been provided.

Accordingly, the fingerprint data 50A may be sent to the lock 30A on the reserved room 40 by the hotel computer system 20 prior to the check-in time or arrival time of the guest on the first date of the reserved period. The scheduling of this transmission of the fingerprint data in digital form to the lock 30A and the means of achieving this by computer system 20 may be no different that with regard to versions of the present invention wherein a combination code 50 is selected by a guest by computer and then transmitted by computer to the combination lock 30. In addition, the storage and maintenance of data with respect to fingerprints may be kept by the hotel 60 as before, for example with respect to digital records-cross-referencing fingerprint data with hotel rooms, the records electronically accessible to a hotel management, recording in the hotel computer system instances when rooms of the hotel have been opened by means of the fingerprint data associated with the rooms, having the records of instances of opening of rooms accessible to a hotel management, and all other features that may be suitably used for this version.

Ultimately, when the guest arrives, the guest may input the guest's fingerprints at a fingerprint input device 39 associated with lock 30A of the reserved room to open the door to the room. The fingerprint input device 39 may have the ability to convert a fingerprint inputted onto it into a digital form and may be able to transmit the digital fingerprint data to the hotel computer 22 or a database 100 for comparison with previously stored data provided by the guest, for example in person. In the event of a match, the fingerprint input device 39 may have the ability to open lock 30A to the door to the room as well as to notify hotel computer 22 that an instance of an opening of such and such room using fingerprint data of a certain identifiable person (identified for example by password or guest identity) has occurred and the time this has occurred. This is in accordance with previously described features of the embodiment employing combination codes.

The fingerprint version of the present invention may be characterized as a method 200 of hotel reservation. Method 200 may include a step 210 of receiving fingerprints associated with a guest identity which a guest may provide in person during a first hotel stay. Method 200 may include a further step 220 by hotel 60 of storing the fingerprints digitally in a database 100. In addition, method 200 may include a step 230 of prompting guests to sign in to a hotel computer system under their guest identity. Step 240 may involve receiving a reservation of a room of the hotel by computer under the guest identity for a set date, where the computer used to reserve the room may be in communication with the hotel computer system 20. Method 200 may also include a step 250 whereby the hotel computer system 20 checks if the guest identity has associated fingerprint data stored on the hotel computer system. Method 200 may in addition have a step 260 whereby the hotel computer system electronically sets a fingerprint code on a lock of the room at a set time, the set time calculated in relation to a check-in time on the set date. Method 200 may also have a further step of comparing a fingerprint inputted by a guest at a fingerprint input device of the lock of the reserved room to fingerprint data in the database and opening the lock of the room if there the fingerprint matches the fingerprint data.

It should be understood, of course, that the foregoing relates to exemplary embodiments of the invention and that modifications may be made without departing from the spirit and scope of the invention as set forth in the following claims.

We claim:

1. A method of hotel reservation without check-in, comprising:
remotely signing in to a hotel computer system under a guest identity;
reserving a room of the hotel by computer under the guest identity for a set date, the computer in communication with the hotel computer system;
selecting a code by computer and electronically transmitting the code to the hotel computer system; and
the hotel computer system electronically setting the code as a combination code on the lock of the room at a set time calculated in relation to a check-in time on the set date.

2. The method of claim 1, wherein the electronic transmitting of the code to the hotel computer system and the electronic setting of the code as a combination code on the lock of the room at the set time occur automatically at the same time.

3. The method of claim 1, wherein the electronic transmitting of the code to the hotel computer system and the electronic setting of the code as a combination code on the lock of the room at the set time occur automatically separated by an intervening act of a hotel personnel.

4. The method of claim 1, wherein the electronic transmitting of the code to the hotel computer system and the electronic setting of the code as a combination code on the lock of the room at the set time occur automatically separated by an intervening time.

5. The method of claim 1, further comprising a guest opening the lock of the room by manually inputting the code at the lock of the room.

6. The method of claim 1, further comprising maintaining and updating timely digital records, the digital records cross-referencing combination codes with hotel rooms, the records electronically accessible to a hotel management.

7. The method of claim 1, further comprising recording in the hotel computer system instances when rooms of the hotel have been opened by means of the combination code associated with the rooms.

8. The method of claim 7, further comprising having the records of instances of opening of rooms accessible to a hotel management.

9. The method of claim 8, further comprising verifying the identity of a guest in person at the hotel.

10. The method of claim 1, further comprising checking out of the hotel by re-setting by computer the combination code of the room.

11. The method of claim 10, wherein the combination code is automatically re-set to a default code chosen by the hotel.

12. The method of claim 1, further comprising a guest selecting an arrival time when selecting the code, whereby the set time is calculated in relation to the arrival time on the set date.

13. The method of claim 1, further comprising changing the code by computer under the guest identity after entry of the guest to the room and electronically transmitting a new code to the hotel computer system, the hotel computer system immediately electronically setting the new code as the combination code on the lock of the room.

14. A hotel reservation system, comprising:
a plurality of hotel rooms, each hotel room having a combination lock that controls entry into that hotel room, the combination lock capable of being electronically set so as to be openable upon input of any one of a plurality of combination codes at the combination lock;
a computer system accessible through a telecommunications network and allowing remote sign-in and reservation of a hotel room for a check-in date from among the plurality of hotel rooms under an identity by payment and selection of a combination code specific to the hotel room,
the computer system, upon electronic notification of a selection of a combination code, automatically electronically setting the combination lock controlling entry to the reserved hotel room so that the combination lock is openable by entering that combination code.

15. The hotel reservation system of claim 14, wherein the computer system is programmed to automatically electronically set the combination lock on the check-in date.

16. The hotel reservation system of claim 14, wherein the computer system is programmed to automatically electronically set the combination lock at a set time on the check-in date, the set time calculated in relation to a check-in time.

17. The hotel reservation system of claim 14, further comprising an on-site check-in kiosk having telecommunications access to the computer system.

18. The hotel reservation system of claim 14, wherein the computer system includes a hotel web site, a hotel computer and software associated with the hotel computer, and wherein the computer system, upon electronic notification of a selection of a combination code by a guest, automatically electronically transmits the combination code to the hotel computer from the hotel web site and further transmits the combination code to the combination lock from the hotel computer along with instructions to set the combination lock to the combination code.

19. A reservation system, comprising:
a plurality of rooms, each room having a combination lock that controls entry into that room, the combination lock capable of being electronically set so as to be openable by any one of a plurality of combination codes whenever the one of the plurality of combination codes is inputted at the combination lock;
computer hardware and software, the hardware linked to a computer system website, the software allowing at the web site a guest to sign in, reserve and pay for a room for a check-in date from among the plurality of rooms, the software prompting and accepting selection of a combination code specific to the room,
the computer hardware and software, upon electronic notification of a selection of a combination code, automatically electronically setting the combination lock controlling entry to the reserved room so that the combination lock becomes openable merely by entering that combination code.

20. The reservation system of claim 19, further comprising a kiosk adjacent the plurality of rooms for on-site reservation.

21. A method of hotel reservation, comprising:
receiving fingerprints associated with a guest identity;
storing the fingerprints digitally in a database;
prompting guests to sign in to a hotel computer system under the guest identity;
receiving a reservation of a room of the hotel by computer under the guest identity for a set date, the computer in communication with the hotel computer system;
checking if the guest identity has associated fingerprint data stored on the hotel computer system; and
the hotel computer system electronically setting a fingerprint code on a lock of the room at a set time, the set time calculated in relation to a check-in time on the set date.

22. The method of claim 21, further comprising comparing a fingerprint inputted by a guest at a fingerprint input device of the lock to fingerprint data in the database and opening the lock if there the fingerprint matches the fingerprint data.
